(19) United States
(12) Patent Application Publication
(10) Pub. No.: US 2026/0075113 A1
(43) Pub. Date: Mar. 12, 2026

(54) Method and Apparatus for Controlling a Diagnosis Session of a Vehicle

(71) Applicant: Bayerische Motoren Werke Aktiengesellschaft, Muenchen (DE)

(72) Inventors: Tobias Heinemann, Erding (DE); Christoph Wierer, Maitenbeth (DE); Bernhard Sass, Muenchen (DE); Bernd Brandl, Muenchen (DE); Ibrahim Ghalawinji, Moosburg a. d. Isaar (DE)

(21) Appl. No.: 19/106,178

(22) PCT Filed: Dec. 7, 2022
(86) PCT No.: PCT/EP2022/084715

§ 371 Date: Feb. 24, 2025

(30) Foreign Application Priority Data
Sep. 23, 2022 (DE) 10 2022 124 470.9

(51) Int. Cl. H04L 67/145; G07C 5/00

(52) U.S. Cl. CPC H04L 67/145; G07C 5/008

(57) ABSTRACT

A method for controlling a diagnosis session of a vehicle includes sending, to a server, a readiness signal indicative of a readiness for the diagnosis session. The method also includes either or both of receiving from the server a first cyclic heartbeat signal, or sending to the server a second cyclic heartbeat signal. The method further includes initializing the diagnosis session based on the first cyclic heartbeat signal or the second cyclic heartbeat signal

The present application is the U.S. national phase of PCT Application PCT/EP2022/084715 filed on Dec. 7, 2022, which claims priority of German patent application No. 10 2022 124 470.9 filed on Sep. 23, 2022, the entire contents of which are incorporated herein by reference.

### TECHNICAL FIELD

The present disclosure relates generally to vehicles, and more specifically, to diagnosis sessions of vehicles.

### BACKGROUND

During monitoring of a vehicle or diagnosis of a vehicle, information transmission takes place between the vehicle and a server, such as a backend. A status of a vehicle can be monitored on the basis of this information transmission. For example, an error search or error elimination in the vehicle can be ensured remotely by the server. The determination of a point in time of the monitoring or a sequence of the monitoring can depend in this case on a large number of parameters. Initializing or carrying out monitoring can thus be made more difficult.

There is therefore a need for providing an improved method for controlling a diagnosis session of a vehicle. The methods, the device, the computer program, and the vehicle according to the independent claims take this need into consideration.

### SUMMARY

Exemplary embodiments of the present invention relate to methods for controlling a diagnosis session for a vehicle, a computer program, a device, and a vehicle, in particular but not exclusively to a concept for initializing a diagnosis session based on a first cyclic heartbeat signal and/or a second cyclic heartbeat signal.

Exemplary embodiments are based on the core concept that a method for controlling a diagnosis session of a vehicle can be initialized based on a first cyclic heartbeat signal and/or a second cyclic heartbeat signal. A point in time for the initialization of the diagnosis session can thus be determined, for example. The point in time can be dependent, for example, on a status of the vehicle, a location of the vehicle, and a presence of a user.

Exemplary embodiments relate to a method for controlling a diagnosis session of a vehicle. The method can be carried out in particular by a vehicle terminal. The method comprises sending, to a server, a readiness signal indicative of a readiness for the diagnosis session. In addition, the method comprises at least one of receiving, from the server, a first cyclic heartbeat signal or sending, to the server, a second cyclic heartbeat signal. Furthermore, the method comprises initializing a diagnosis session based on the first cyclic heartbeat signal and/or the second cyclic heartbeat signal. Information about a possibility for initializing a diagnosis session by way of the server/vehicle terminal can be transmitted by the receiving/sending of the first/second cyclic heartbeat signal. Initialization of the diagnosis session can thus be improved. In particular, the initialization of the diagnosis session can take place when both the server and the vehicle terminal can enable carrying out a diagnosis session.

In one exemplary embodiment, the first cyclic heartbeat signal and the second cyclic heartbeat signal can be indicative of a parameter of the diagnosis session. The first/second cyclic heartbeat signal can thus be used to transmit parameters of the diagnosis session. Information transmission during the diagnosis session can thus be simplified.

In one exemplary embodiment, the method can furthermore comprise ending the diagnosis session if neither the first cyclic heartbeat signal can be received nor the second cyclic heartbeat signal can be sent. An interruption in the diagnosis session can be determined by the first cyclic heartbeat signal and/or the second cyclic heartbeat signal. A diagnosis session, for example, in the event of faulty communication between the vehicle terminal and the server, can thus be ended faster. By ending the diagnosis session, an original status of the vehicle can be reestablished, due to which the security (for example, a cybersecurity of a firewall, an operational security of a diagnosis session) can be enhanced.

In one exemplary embodiment, the method can furthermore comprise changing a firewall setting during a performance of the diagnosis session. A communication between the vehicle terminal and the server can be simplified and/or a possibility for performing diagnosis steps can be improved by the change of the firewall setting.

In one exemplary embodiment, the method can furthermore comprise determining a status of the vehicle and ending the diagnosis session based on the determined status of the vehicle. For example, a user can start the motor of the vehicle to drive away. A connection between the vehicle terminal and the server can be worsened due to the driving away. Accordingly, the diagnosis session could be ended as a precaution before it is interrupted. A reliability of the diagnosis session can thus be enhanced.

In one exemplary embodiment, the method can furthermore comprise obtaining at least one criterion of a presence of a user of the vehicle, obtaining a consent of the user, and/or determining a status of the vehicle. The diagnosis session can be initialized only if at least one of the criteria has been obtained. It can thus be ensured that a diagnosis session can only be started under specific conditions, by which a misuse can be made more difficult.

In one exemplary embodiment, the method can furthermore comprise obtaining surroundings information and/or position information. The second cyclic heartbeat signal can furthermore be indicative of the surroundings information and/or position information. The server can thus be informed about conditions for the diagnosis session. For example, a free space around the vehicle can be required for a planned action. This information can be transmitted to the server by the second cyclic heartbeat signal, by which a diagnosis session can be improved, for example, specific diagnosis steps can be enabled.

In one exemplary embodiment, the method can furthermore comprise receiving, from the server, a request signal indicative of a request to initialize the diagnosis session. Furthermore, the readiness signal can be a response signal indicative of a response to the request signal. A server can thus actively start a required diagnosis session, for example.

In one exemplary embodiment, the first cyclic heartbeat signal can be indicative of erasing a vehicle error memory. Furthermore, the method can comprise erasing a vehicle error memory based on the first cyclic heartbeat signal. The vehicle can thus be put back into an operationally-ready status, for example. A data transfer can be minimized by the integration of the information in the first cyclic heartbeat signal.

In one exemplary embodiment, the method can furthermore comprise determining an operationally-ready status of the vehicle and sending a final heartbeat signal of the second cyclic heartbeat signal indicative of the operationally-ready status. Furthermore, the method can comprise ending the diagnosis session. The vehicle terminal can thus end the diagnosis session after a successful diagnosis session, for example, after remedying a faulty status of the vehicle, by which a further data transfer can be avoided.

In one exemplary embodiment, the method can furthermore comprise determining a status of the vehicle and determining a remaining diagnosis session time based on the status of the vehicle. The second cyclic heartbeat signal can furthermore be indicative of the remaining diagnosis session time. For example, the diagnosis session time can depend on a state of charge of a battery of the vehicle. The server can be informed about which diagnosis session time is still available. A control of the diagnosis session can thus be improved, for example, tasks still to be performed can be planned accordingly or postponed to a later diagnosis session.

Exemplary embodiments relate to a method for controlling a diagnosis session of a vehicle. The method can be performed in particular by a server, such as a backend. The method comprises receiving, from a vehicle terminal, a readiness signal indicative of a readiness for the diagnosis session. Furthermore, the method comprises sending, to the vehicle terminal, a first cyclic heartbeat signal and/or receiving, from the vehicle terminal, a second cyclic heartbeat signal. Furthermore, the method comprises initializing a diagnosis session based on the first cyclic heartbeat signal and/or the second cyclic heartbeat signal. An initialization of the diagnosis session can thus be improved. In particular, the initialization of the diagnosis session can take place if both the server and the vehicle terminal can enable a performance of a diagnosis session.

In one exemplary embodiment, the first cyclic heartbeat signal can be indicative of a status request of the vehicle and the second cyclic heartbeat signal can be indicative of a status of the vehicle. Furthermore, the method can comprise determining a remaining diagnosis session time based on the status of the vehicle. A control of the diagnosis session can thus be improved, for example, tasks still to be performed can be planned accordingly or postponed to a later diagnosis session.

Exemplary embodiments also provide a computer program for carrying out one of the methods described herein when the computer program runs on a computer, a processor, or a programmable hardware component.

A further exemplary embodiment is a device for controlling a diagnosis session of a vehicle. The device comprises an interface for communication with other communication devices (for example, the server or a vehicle terminal) and a data processing circuit which is designed to perform at least one of the methods described herein. Exemplary embodiments additionally provide a vehicle having a device as described herein.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a schematic representation of a method for controlling a diagnosis session of a vehicle;

FIG. 2 shows a schematic representation of a further method for controlling a diagnosis session of a vehicle;

FIG. 3 shows a flow chart of a diagnosis session; and

FIG. 4 shows a block diagram of an exemplary embodiment of a device for controlling a diagnosis session of a vehicle.

### DETAILED DESCRIPTION

Various exemplary embodiments will now be described in more detail with reference to the appended drawings, in which several exemplary embodiments are shown. The thickness dimensions of lines, layers, and/or regions can be shown exaggerated for the sake of clarity in the figures.

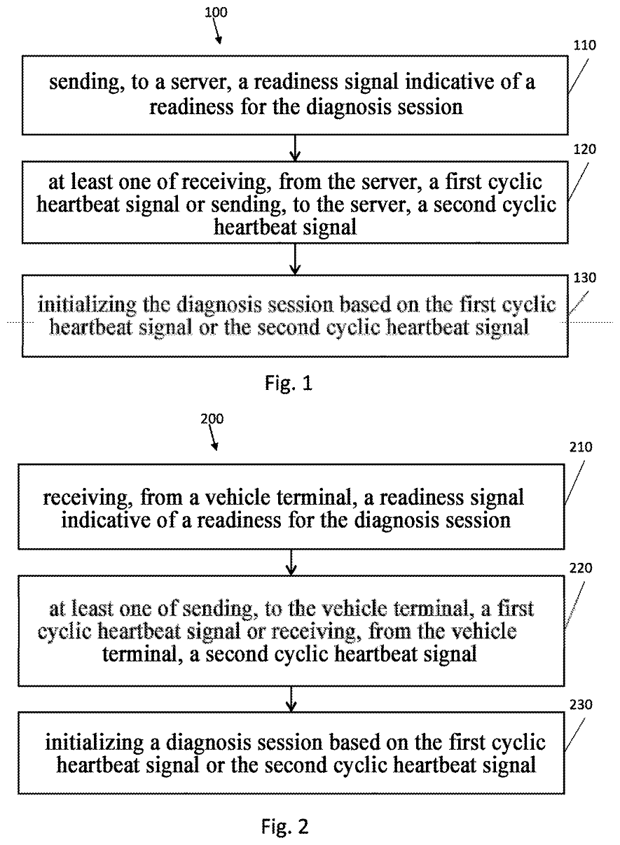

FIG. 1 shows a schematic representation of a method 100 for controlling a diagnosis session of a vehicle. The method 100 can in particular be performed by a vehicle terminal. The method 100 comprises sending 110, to a server, a readiness signal indicative of a readiness for the diagnosis session. The readiness signal can be sent by the vehicle terminal when a diagnosis session can be initialized on the part of the vehicle.

In addition, the method 100 comprises receiving 120, from the server, a first cyclic heartbeat signal and/or sending, to the server, a second cyclic heartbeat signal. The first cyclic heartbeat signal can be used in particular to indicate to the vehicle an intact communication connection to the server. The second cyclic heartbeat signal can in particular be used to indicate to the server an intact communication connection to the vehicle. The first/second cyclic heartbeat signal can thus improve a performance of the diagnosis session. The vehicle and/or the server can obtain information about the connection to one another. The first/second cyclic heartbeat signal can be, for example, a periodic signal. The first cyclic heartbeat signal can be received, for example, at time intervals of at most 80 seconds, or 70 seconds, or 60 seconds and/or of at least 30 seconds, or 40 seconds, or 50 seconds. The second cyclic heartbeat signal can be sent, for example, at time intervals of at most 80 seconds, or 70 seconds, or 60 seconds and/or of at least 30 seconds, or 40 seconds, or 50 seconds. Alternatively, the first cyclic heartbeat signal and/or the second cyclic heartbeat signal can be sent at shorter intervals, for example, at most every 10 seconds, or 5 seconds, or 2 seconds. This can be advantageous if there is an increased need for information exchange between the vehicle terminal and the server. For example, changes of the status of the vehicle can thus be sent faster to the server.

Furthermore, the method 100 comprises initializing 130 a diagnosis session based on the first cyclic heartbeat signal and/or the second cyclic heartbeat signal. The diagnosis session can be initialized both by the vehicle and also the server. In particular, an initialization from vehicle and server can be required to establish the diagnosis session.

A diagnosis session can be used in particular for monitoring, for example, for maintenance, of the vehicle. For example, during the diagnosis session, an information exchange can take place between the vehicle terminal and the server for monitoring the vehicle, for example, a status of the vehicle. The information exchange can take place in this case from the vehicle terminal to the server, for example, to transmit information about the vehicle to the server. In addition, an information exchange can also take place from the server to the vehicle terminal, for example, to transmit control commands to the vehicle.

In principle, a diagnosis session can be divided into various partial diagnosis sessions. The various partial diagnosis sessions can provide different functionalities. In a first partial diagnosis session, for example, only an information exchange from the vehicle terminal to the server can take place. The first partial diagnosis session can thus be viewed as a read-only diagnosis session. In particular, only information can be sent from the vehicle terminal to the server in a read-only diagnosis session. An information exchange can thus be enabled without changing parameters of the vehicle or the vehicle terminal, for example, a firewall setting. A security of the vehicle terminal or of the vehicle therefore cannot be affected by the read-only diagnosis session.

In second partial diagnosis session, for example, an information exchange can additionally take place from the server to the vehicle terminal. The second partial diagnosis session can thus be viewed as a full-access diagnosis session. For example, the server can send a control command to the vehicle terminal. The control command can be comprised by the second cyclic heartbeat signal. Alternatively, the control command can be comprised by a separate signal, for example, a control signal. The control signal may not be comprised by the first cyclic heartbeat signal. A functionality of the diagnosis session can therefore be enhanced. To perform full-access diagnosis session, it can be necessary to change a parameter, for example, a firewall setting of the vehicle or the vehicle terminal, due to which a security of the vehicle terminal or the vehicle can be reduced.

A duration in a critical status of the vehicle, for example, in a full-access diagnosis session, can be reduced by the division into various partial diagnosis sessions. For example, a change of the firewall setting of the vehicle and/or the vehicle terminal can be necessary to perform certain diagnosis steps. A security, for example, against attacks, can thus be reduced, because of which this setting of the firewall is supposed to be maintained as much as possible only for performing the specific diagnosis steps. A duration of a security-critical status of the vehicle can be minimized by the use of a full-access diagnosis session in combination with a read-only diagnosis session. For example, in a read-only diagnosis session, first obtaining information by the server can take place. A full-access diagnosis session can then be initialized based on the obtained information. A duration of the vehicle or the vehicle terminal in a full-access diagnosis session can thus be reduced, by which an energy consumption is reduced, for example, an energy consumption of the vehicle battery.

By means of the first cyclic heartbeat signal and/or the second cyclic heartbeat signal, a status monitoring of the vehicle and/or the communication connection between the vehicle terminal and the server can take place. The first cyclic heartbeat signal and/or the second cyclic heartbeat signal can be a keep alive signal. The first cyclic heartbeat signal and/or the second cyclic heartbeat signal can be indicative that the diagnosis session can be performed. As long as the first cyclic heartbeat signal and/or the second cyclic heartbeat signal can be received/sent, the diagnosis session can be maintained.

The information exchange can take place via the first cyclic heartbeat signal and/or the second cyclic heartbeat signal. The first cyclic heartbeat signal and/or the second cyclic heartbeat signal can thus comprise the information to be exchanged. For example, the vehicle terminal can send information about a status of the vehicle with the second cyclic heartbeat signal to the server. In one exemplary embodiment, the readiness signal can be comprised by a first heartbeat signal of the second cyclic heartbeat signal or can be this signal. For example, the readiness for the diagnosis session can thus be sent by means of the second cyclic heartbeat signal.

The connection between the vehicle terminal and the server can be monitored using the first cyclic heartbeat signal and/or the second cyclic heartbeat signal. A diagnosis session, thus, for example, a transmission of information for the error search and error elimination in the vehicle, can thus be ensured remotely. In other systems, it is not possible to detect an interrupted connection between the vehicle terminal and the server. It can only be determined indirectly by the timeout of a request when no response takes place that no connection exists. A connection status between the vehicle terminal and the vehicle cannot be determined in this case, however. The status of the connection between the vehicle terminal and the server can be determined by the use of the first cyclic heartbeat signal and/or the second cyclic heartbeat signal. A control of the diagnosis session for the vehicle can thus be improved.

The first cyclic heartbeat signal and/or the second cyclic heartbeat signal can in particular be sent during a duration of the diagnosis session. The connection between the vehicle terminal and the server and optionally at the same time a status of the vehicle can thus be monitored. A cyclic and/or event-triggered monitoring of the status of the vehicle can be performed by the first cyclic heartbeat signal and/or the second cyclic heartbeat signal. An event can be a status change of the vehicle, for example, opening a door, a battery status which is discharged excessively strongly, a change of a movement status of the vehicle. It is therefore possible to react to a status change of the vehicle. For example, a diagnosis session can be ended if an actuation having a high energy consumption is present or a movement status of the vehicle is changed.

In general, a communication device, such as the server and/or the vehicle terminal, can be a device which is capable of communicating wirelessly. The vehicle terminal can be, for example, a control device of the vehicle. The vehicle terminal can thus be integrated into the vehicle. Alternatively, the vehicle terminal can be a user terminal. A user terminal can be suitable for being worn by a user. For example, the user terminal can be a smartphone, a smartwatch, a virtual reality headset. Software can be installed on the user terminal, for example, software of a producer of the vehicle, which enables a communication with the vehicle. The user terminal can receive data relating to a diagnosis session from the vehicle and forward these data to the server or receive these data from the server and forward these data to the vehicle. The user terminal can thus act like a relay, for example. A communication connection between the vehicle terminal and the server can thus be used to control the diagnosis session of the vehicle. For example, the vehicle terminal can be configured to enable an access to the vehicle, for example, the vehicle terminal can be configured as a smart key. It can thus be ensured that data for the diagnosis session are sent from the vehicle only to a certified vehicle terminal.

A connection between the server and the vehicle terminal can be a wireless connection, for example, a millimeter wave-based connection via the mobile communication system (for example, using carrier frequencies of at least 20 GHz), or it can take place using lower carrier frequencies, for example, using carrier frequencies of at most 7.5 GHz. The wireless connection between the server and the vehicle terminal can be established, for example, via the protocols of the mobile communication system or via a close-range communication system, such as a wireless local network.

In one exemplary embodiment, the first cyclic heartbeat signal and the second cyclic heartbeat signal can be indicative of a parameter of the diagnosis session. The parameter of the diagnosis session can be, for example, information about a status of the vehicle, a request of the server (for example, for required information), a control command of the vehicle, for example, to change a position and/or alignment of an exterior mirror, a control command for the vehicle terminal, for example, to change the firewall setting. The information exchange between the vehicle terminal and the server can thus take place in a simplified manner by means of the first cyclic heartbeat signal and/or the second cyclic heartbeat signal.

The first cyclic heartbeat signal and/or the second cyclic heartbeat signal can be used to end the diagnosis session. In one exemplary embodiment, the method can furthermore comprise ending the diagnosis session if neither the first cyclic heartbeat signal can be received and/or the second cyclic heartbeat signal cannot be sent. If the first cyclic heartbeat signal and/or the second cyclic heartbeat signal can no longer be received/sent, a connection between the vehicle terminal and the server can be disturbed or interrupted. In this case, the diagnosis session can be ended, for example, to end a security-critical status of the vehicle or the vehicle terminal. For example, the diagnosis session can be ended in the event of a faulty communication between the vehicle terminal and the server. During the diagnosis session, it can be necessary to deactivate a security setting of the vehicle or vehicle terminal, due to which a probability of an attack can increase. A security of the vehicle terminal or vehicle can be enhanced again by improved ending of the diagnosis session.

The diagnosis session can be ended if it has not been possible to receive/send a specific number of first cyclic heartbeat signals and/or second cyclic heartbeat signals. For example, the diagnosis session can be ended if it has not been possible to receive/send a heartbeat signal of the first cyclic heartbeat signal and/or the second cyclic heartbeat signal. Optionally or alternatively, the diagnosis session can be ended if it has not been possible to receive/send a plurality of successive heartbeat signals of the first cyclic heartbeat signal and/or the second cyclic heartbeat signal. The diagnosis session can thus be interrupted in the event of an interruption of the communication connection. Optionally or alternatively, the diagnosis session can be ended if it has not been possible to receive/send a plurality of heartbeat signals of the first cyclic heartbeat signal and/or the second cyclic heartbeat signal in a defined time interval. The diagnosis session can thus be ended in the event of an inadequate quality of the communication connection.

Optionally, if the diagnosis session was ended based on an absent first cyclic heartbeat signal and/or an absent second cyclic heartbeat signal, the vehicle and/or the vehicle terminal can be reset into a starting status before initialization of the diagnosis session. It can thus be ensured that no change was performed on the vehicle and/or the vehicle terminal by the diagnosis session which impairs a functionality of the vehicle and/or the vehicle terminal. Deliberate changes which were performed during the diagnosis session, for example, to eliminate a fault, are excluded therefrom. Deliberate changes can be, for example, changes during the diagnosis session which have eliminated a fault. For example, a vehicle can have two different faults at the beginning of a diagnosis session. It is possible for a diagnosis session to have been ended based on an absent first cyclic heartbeat signal after a first fault was eliminated. This first fault can then remain eliminated if the vehicle is reset into the starting state.

In one exemplary embodiment, the method can furthermore comprise changing a firewall setting during a performance of the diagnosis session. A function for the diagnosis session, for example, for specific diagnosis steps, can be permitted by the change of the firewall setting. A change can also be an update of the firewall setting and/or the firewall, for example, by a software update. In particular various remote operations for the server can be enabled by the change of the firewall setting. For example, information can be displayed to a user of the vehicle via a display in the vehicle and/or the vehicle terminal, for example, a remaining diagnosis session time or a currently performed action, a third party who performs the diagnosis session.

The first cyclic heartbeat signal and/or the second cyclic heartbeat signal can be used to perform cyclic and/or event-triggered monitoring of the high-voltage and/or low-voltage power management. A battery status of the vehicle can thus be monitored. For example, a remaining diagnosis session time until an excessively strong discharge of the battery occurs can be determined based on the battery status of the vehicle. In one exemplary embodiment, the method can furthermore comprise determining a status of the vehicle and ending the diagnosis session based on the determined status of the vehicle. The diagnosis session can be ended, for example, based on the battery status of the vehicle or a change of a movement status of the vehicle.

In one exemplary embodiment, the method can furthermore comprise obtaining at least one criterion of a presence of a user of the vehicle, obtaining a consent of the user, and/or determining a status of the vehicle. The obtaining can be carried out by a determination, for example, by means of a sensor of the vehicle. The vehicle can determine, for example, a presence of the user by determining a user terminal, which is configured as a smart key for the vehicle. Optionally or alternatively, the obtaining can be carried out by a reception. The vehicle terminal can be integrated in the vehicle. For example, the vehicle terminal can obtain a consent signal indicative of a consent to a diagnosis session from a user, for example, from a smartphone of a user or from a display of the vehicle (which the user can touch for the consent). For a diagnosis session which requires a consent of the user, this consent can thus be obtained. For example, a point in time for a diagnosis session can be determined more accurately because a usage intention of the vehicle by the user can be taken into consideration. In particular, a consent can only be required for certain partial diagnosis sessions, for example, a full-access diagnosis session. For a read-only diagnosis session, for example, no or a less strict consent can be necessary.

A consent to a diagnosis session can be given, for example, by a consent to general terms and conditions. This consent can then be used, for example, to initialize a read-only diagnosis session. In contrast, for a full-access diagnosis session, an additional condition, for example, another consent, for example, an identification via an application on a user terminal (for example, the vehicle terminal) or a presence of a user at the vehicle can be required. An initialization of a security-critical partial diagnosis session, for example, a full-access diagnosis session, can thus be linked to a plurality of conditions.

Optionally or alternatively, the obtaining can comprise receiving from the vehicle. The vehicle terminal can be a user terminal and can obtain a status signal indicative of the status of the vehicle from the vehicle. The vehicle terminal can thus send the readiness signal based on the status signal to the server, for example, when a diagnosis session can be required due to a faulty status of the vehicle.

In one exemplary embodiment, the method can furthermore comprise obtaining surroundings information and/or position information. The second cyclic heartbeat signal can furthermore be indicative of the surroundings information and/or position information. In that the second cyclic heartbeat signal can be indicative of the surroundings information and/or the position information, this can be sent to the server. A diagnosis session or a diagnosis step can thus be performed based on the surroundings information and/or the position information. The surroundings information can be determined using a sensor of the vehicle, for example, a UWB sensor, an ultrasonic sensor, a lidar sensor, a radar sensor. The position information can be determined, for example, by means of GPS.

For example, a full-access diagnosis session can only be initialized for a specific position of the vehicle, for example, in a repair shop. For example, a specific diagnosis step can only be executed in specific surroundings. Extending the exterior mirrors or the trailer hitch can be necessary for a diagnosis step. Accordingly, this diagnosis step can only be executed when the surroundings around the vehicle is free. The information about the free surroundings can be sent by means of the second cyclic heartbeat signal. The sensor information can be sent to the server. Alternatively, only information about the free surroundings can also be sent to the server. A data volume can thus be reduced.

Receiving the surroundings information enables monitoring of a sensor of the vehicle. The server can thus deliberately actuate actuators in the vehicle, for example, to extend the exterior mirrors, in order to change a position of the exterior mirrors temporarily for the diagnosis step, for example. Diverse diagnosis steps can be enabled by this monitoring.

In one exemplary embodiment, the method can furthermore comprise sending status information to the server. The status information can be indicative of the status of the vehicle. The status information can be comprised by the second cyclic heartbeat signal. For example, a specific diagnosis step can only be performed in the case of a status of the vehicle, for example, with a closed front hatch. Monitoring the front hatch can enable multiple security-critical diagnosis session actuations in the diagnosis session, such as that of an electric fan, of radiator blinds, or of running the engine. Furthermore, changes of the status of the vehicle can thus be transmitted to the server, due to which this server can perform suitable measures, for example, ending the diagnosis session in the event of a change of a movement status of the vehicle.

In one exemplary embodiment, the method can furthermore comprise determining a status of the vehicle and determining a remaining diagnosis session time based on the status of the vehicle. The second cyclic heartbeat signal can furthermore be indicative of the remaining diagnosis session time. For example, the diagnosis session time can depend on a state of charge of a battery of the vehicle or a schedule of a user of the vehicle. The server can be informed about which diagnosis session time is still available. A control of the diagnosis session can thus be improved, for example, tasks still to be performed can be planned accordingly or postponed to a later diagnosis session.

In one exemplary embodiment, the method can furthermore comprise receiving, from the server, a request signal indicative of a request for an initialization of the diagnosis session. Furthermore, the readiness signal can be a response signal indicative of a response to the request signal. A server can thus actively start a required diagnosis session.

In one exemplary embodiment, the first cyclic heartbeat signal can be indicative of erasing a vehicle error memory. Furthermore, the method can comprise erasing a vehicle error memory based on the first cyclic heartbeat signal. For example, a status of the vehicle can be faulty. The vehicle can then send a readiness signal to the server and a diagnosis session can be initialized. If the faulty status of the vehicle can be remedied in the diagnosis session, the server can send the information to erase the vehicle error memory to the vehicle terminal. The vehicle can thus be put into an operationally-ready status.

In one exemplary embodiment, the method can furthermore comprise determining an operationally-ready status of the vehicle and sending a final heartbeat signal of the second cyclic heartbeat signal indicative of the operationally-ready status. Furthermore, the method can comprise ending the diagnosis session. The vehicle terminal can thus send information to the server so that a diagnosis session can be ended. Accordingly, the server can be informed that a lack of sending of the second cyclic heartbeat signal can be induced not by an interrupted communication connection, but rather that sending the second cyclic heartbeat signal was ended.

Further details and aspects are mentioned in conjunction with the exemplary embodiments described below. The exemplary embodiment shown in FIG. 1 can comprise one or more optional additional features which correspond to one or more aspects which were mentioned in conjunction with the proposed concept or one or more exemplary embodiments described below (for example, FIGS. 2-4).

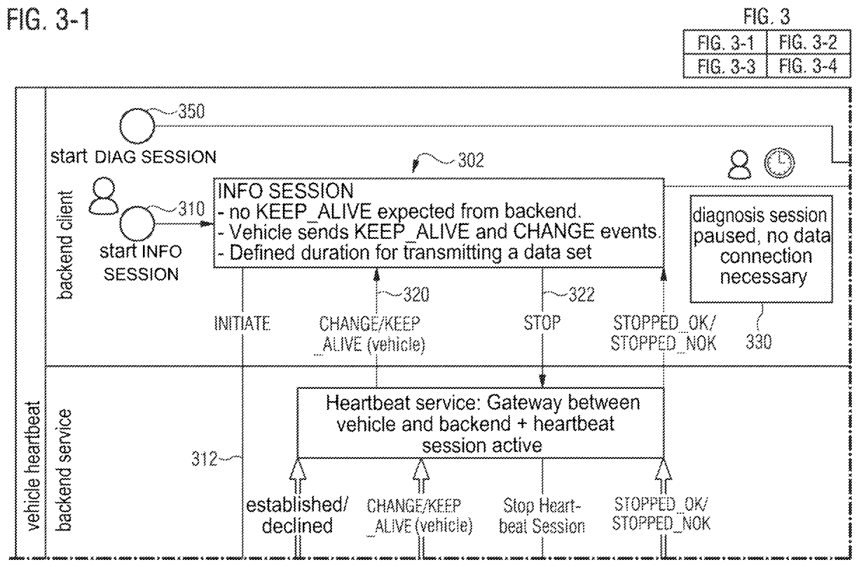

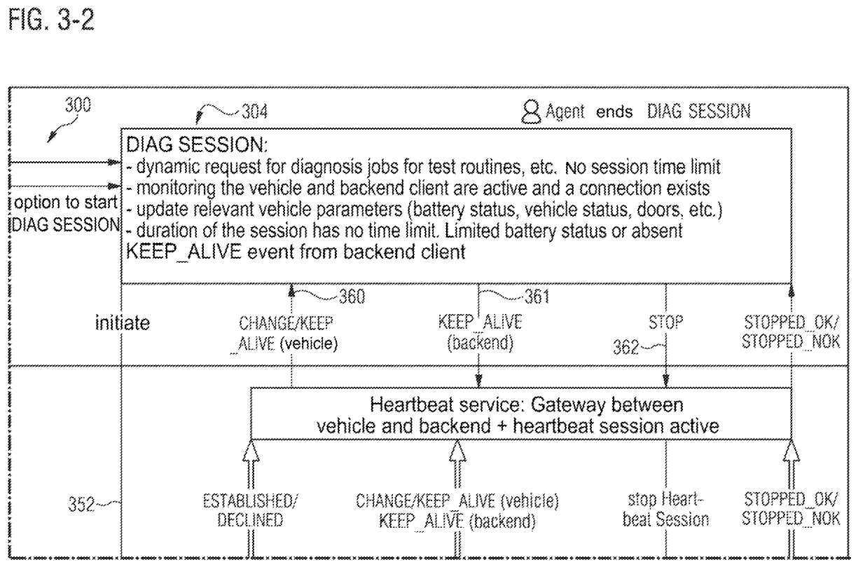

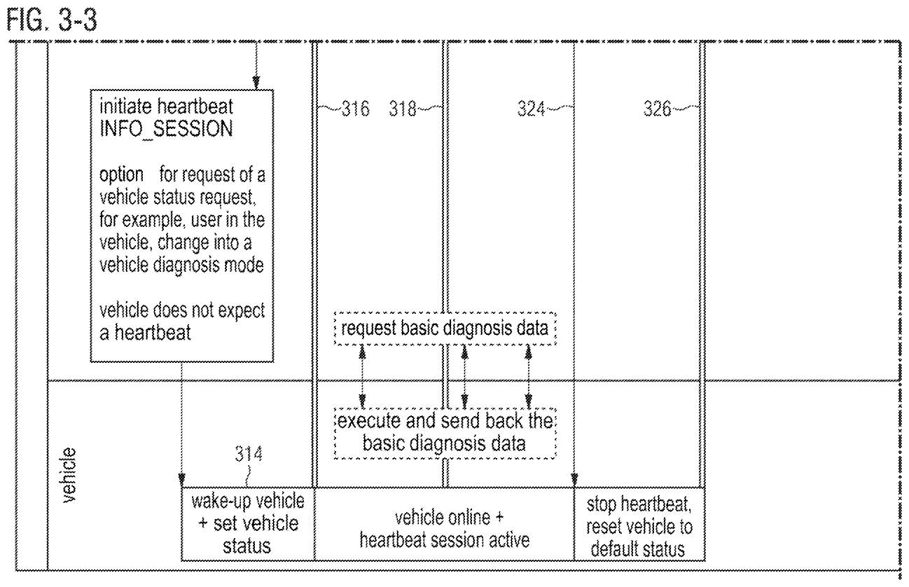

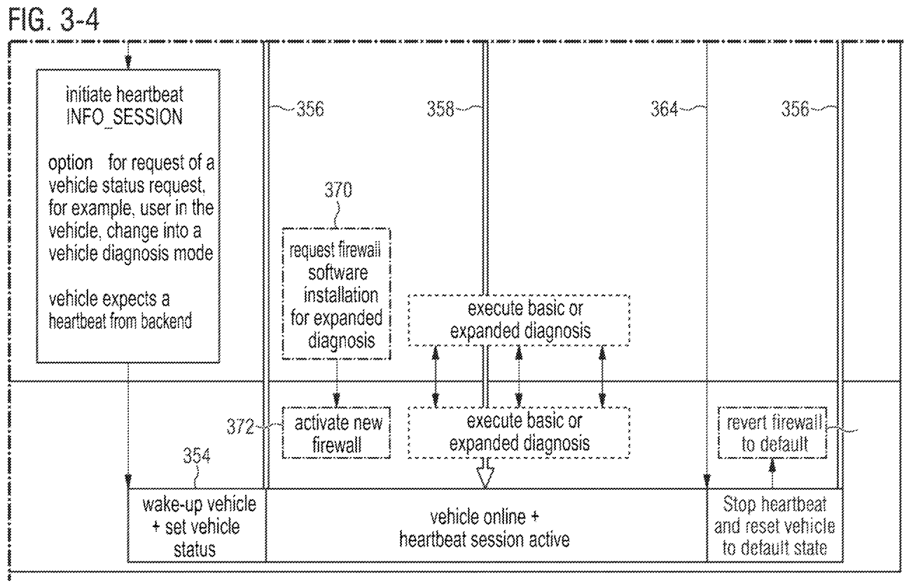

FIG. 2 shows a schematic representation of a further method 200 for controlling a diagnosis session of a vehicle. The method 200 can be performed by a server, for example, a backend. The method 200 can be performed by a counterpart of a vehicle terminal which can perform the method in FIG. 1. For example, the server which carries out a method 200 and the vehicle terminal which carries out a method as described in FIG. 1 can exchange information with one another in an overall system in order to perform both methods (see, for example, FIG. 3).

The method 200 comprises receiving 210, from a vehicle terminal, a readiness signal indicative of a readiness for the diagnosis session. Furthermore, the method 200 comprises sending 220, to the vehicle, a first cyclic heartbeat signal and/or receiving, from the vehicle, a second cyclic heartbeat signal. Furthermore, the method 200 comprises initializing 230 a diagnosis session based on the first cyclic heartbeat signal and/or the second cyclic heartbeat signal. An initialization of the diagnosis session can thus be improved. In particular, the initialization of the diagnosis session can take place when both the server and the vehicle terminal can enable a performance of a diagnosis session.

In one exemplary embodiment, the first cyclic heartbeat signal can be indicative of a status request of the vehicle and the second cyclic heartbeat signal can be indicative of a status of the vehicle. Furthermore, the method can comprise determining a remaining diagnosis session time based on the status of the vehicle. A control of the diagnosis session can thus be improved, for example, tasks still to be performed can be planned accordingly or postponed to a later diagnosis session.

In a full-access diagnosis session, the server can determine whether ending the full-access diagnosis session is necessary if the second cyclic heartbeat signal can no longer be received by the server. For example, the server can send a stop heartbeat signal to the vehicle terminal, indicative of ending the sending of the second cyclic heartbeat signal. The server can then end the full-access diagnosis session. Optionally, the server can only end the full-access diagnosis session when a response to the stop heartbeat signal has been received from the vehicle terminal or when a timeout time for receiving a response has been exceeded.

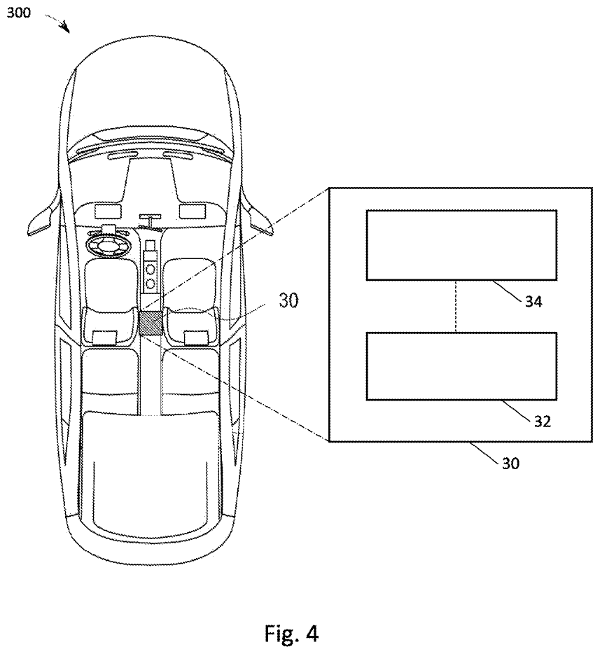

Further details and aspects are mentioned in conjunction with the exemplary embodiments described below and/or above. The exemplary embodiment shown in FIG. 2 can comprise one or more optional additional features which correspond to one or more aspects which were mentioned in conjunction with the proposed concept or one or more exemplary embodiments described above (for example, FIG. 1) and/or below (for example, FIGS. 3-4).

FIG. 3 shows a flow chart of a diagnosis session 300. The diagnosis session 300 comprises a first partial diagnosis session 302 and a second partial diagnosis session 304. The first partial diagnosis session 302 is a read-only diagnosis session. The second partial diagnosis session 304 is a full-access diagnosis session.

The first partial diagnosis session 302 and the second partial diagnosis session 304 can be started at different points in time. In 310, the first partial diagnosis session 302, also referred to as an info session 302, can be started. In the info session 302, only a second cyclic heartbeat signal can be sent from the vehicle terminal to the server, for example, a backend client. Since the info session 302 can be only a partial diagnosis session for information transmission from the vehicle terminal (for example, comprised by the vehicle) to the server, receiving a first cyclic heartbeat signal can be omitted. In particular, the vehicle terminal may not require information about whether the server can transmit information to the vehicle terminal. In the info session 302, no information transmission can take place from the server. A time limit of the info session 302 can be predefined. The vehicle can thus end the info session 302 after the time limit expires.

The server can in particular comprise the backend client and the backend service. The backend client can be, for example, an artificial intelligence or a program which is trained or configured to perform the diagnosis session 300.

In 350, the second partial diagnosis session 304, also referred to as a diag session 304, can be started. In the diag session 304, dynamic requests for dynamic diagnosis steps for test routines can be sent from the server to the vehicle terminal, in particular by means of the first cyclic heartbeat signal or a control signal. No time limit can exist for the dynamic requests.

Furthermore, continuous monitoring of the communication connection between the server and the vehicle terminal can take place in the diag session 304, in particular by way of the first cyclic heartbeat signal and the second cyclic heartbeat signal. In addition, in the diag session 304, the vehicle terminal can send relevant information for the server with respect to the status of the vehicle to the server. For example, information about a battery status, the status of the vehicle (for example, locked, unlocked), and/or the doors of the vehicle can be sent.

In principle, the backend client (agent) can decide which partial diagnosis session 302, 304 is started. The info session 302 can have a predefined time limit. The predefined time limit can be stored in the vehicle terminal. In particular, no first cyclic heartbeat signal can be required for the performance of the info session 302. The diag session 304 can have no predefined time limit. Furthermore, the second cyclic heartbeat signal can be required in the diag session 304. Optionally, a parameter such as a presence of a user, a status of the vehicle, a location of the vehicle can be required for starting 350 the diag session 304. If this condition is not met, the vehicle terminal can reject starting 350 of the diag session 304.

In 312/352, the backend client can send a request signal to the vehicle terminal. This request signal can be used to request an info session 302/diag session 304. With the request signal, the backend client can also send a specific condition for initializing the info session 302/diag session 304. For example, a presence of a user or a change of the status of the vehicle into a diagnosis status can be required.

In 314/354, the vehicle can be woken up by the vehicle terminal based on the request signal. Furthermore, a status of the vehicle can be changed by the vehicle terminal to a status suitable for the info session 302/diag session 304. If an initialization of the info session 302/diag session 304 is not possible, for example, because the specific condition is not met, in 316/356, an acceptance signal/rejection signal indicative of an acceptance/rejection of the request for the info session 302/diag session 304 can be sent to a backend client.

In 318/358, the second cyclic heartbeat signal can be sent to the backend client and in 358 the first cyclic heartbeat signal can optionally be sent to the vehicle terminal from the backend client. This can take place in particular if the vehicle is in a diagnosis status and the diagnosis session, also called a heartbeat session, is active. The heartbeat session can be active as long as the first cyclic heartbeat signal and/or the second cyclic heartbeat signal is being sent.

In 320/360, the second cyclic heartbeat signal is sent from the backend service to the backend client. The first cyclic heartbeat signal and/or the second cyclic heartbeat signal can be sent as a keep alive signal. In the info session 302, further information can be sent by means of the second cyclic heartbeat signal, for example, a battery status or a status of a door. In particular, information about an event can thus be sent, for example, opening of a door. Furthermore, the second cyclic heartbeat signal can comprise critical information for the diagnosis session, for example, a state of charge of the vehicle battery. If a vehicle battery is discharged excessively strongly, it can be necessary to end the diagnosis session immediately.

In the diag session 304, the backend client can send the first cyclic heartbeat signal in 361. If the vehicle terminal cannot receive the first cyclic heartbeat signal, for example, multiple successive heartbeat signals of the first heartbeat signal, the vehicle terminal can end the diag session 304. A security of the vehicle terminal can thus be enhanced.

In 322/362, a stop signal can be sent from the backend client to the backend service. The stop signal can be sent from the backend client to the vehicle terminal in 324/364. The stop signal can in particular be comprised by or can be a final heartbeat signal of the first cyclic heartbeat signal. If no first cyclic heartbeat signal is sent by the backend client in the info session 302, the info session 302 can be ended by the vehicle terminal.

In 326/356, a confirmation message can be sent from the vehicle terminal to the backend client that the diagnosis session can be ended. This confirmation can be comprised by or can be, for example, a final heartbeat signal of the second cyclic heartbeat signal. The vehicle terminal can change a status of the vehicle after ending the sending of the second cyclic heartbeat signal, for example, it can trigger an energy-saving mode of the vehicle.

The diag session 304 can only be ended, for example, by a stop signal 362. Furthermore, the vehicle terminal can confirm the ending of the diag session 304 with a confirmation message in 366 only if a status of the vehicle is present, for example, a status before beginning the diag session 304. For example, if a status of the vehicle from before the diag session cannot be reestablished, the vehicle terminal can send a nonconfirmation message indicative of a problem with the reestablishment of the status of the vehicle in 366. In this case, the backend client can take measures to enable a reestablishment of the status of the vehicle, for example, contact a user or repeat a diagnosis step.

The info session 302 and/or the diag session 304 can also be ended by the vehicle terminal, for example, if an engine of the vehicle is started or a battery status which is discharged excessively strongly is present.

The info session 302 can be used to obtain information for a diag session 304. A duration of a more security-critical diag session 304 can thus be reduced or a diag session can be completely avoided. In 330, a diagnosis session can be interrupted after an info session 302 has been carried out. During the interruption, an evaluation of the information obtained from the vehicle can take place. For this purpose, in particular none of the first cyclic heartbeat signal and second cyclic heartbeat signal can be necessary. Based on an evaluation of the information, it can then be determined whether a diag session 304 is required. If a diag session 304 is required, this can be initialized following the info session 302 or the evaluation.

For the diag session 304, the vehicle terminal can receive a request in 370 to change a firewall setting, for example, by installing a special firewall suitable for a diag session 304. For example, the special firewall can comprise a rule set which can be activated temporarily (for the duration of the diag session 304), by which a central firewall setting can be changed or suppressed. The special firewall can be activated in 372 by the vehicle terminal. The backend client can thus obtain better access to the vehicle terminal or the vehicle. With ending of the diag session 304, the firewall can be reset to an original status in 374. A normal security of the vehicle terminal can thus be reestablished.

Further details and aspects are mentioned in conjunction with the exemplary embodiments described below and/or above. The exemplary embodiment shown in FIG. 2 can comprise one or more optional additional features which correspond to one or more aspects which were mentioned in conjunction with the proposed concept or one or more exemplary embodiments described above (for example, FIG. 1) and/or below (for example, FIGS. 3-4).

FIG. 4 shows a block diagram of an exemplary embodiment of a device 30 for controlling a diagnosis session of a vehicle 400. The device 30 comprises an interface 32 for communication with a user terminal (for example, the server or the vehicle terminal). The device 30 furthermore comprises a data processing circuit 34, which is designed to perform at least one of the methods described herein, for example, the method which is described with reference to FIG. 1 for the vehicle terminal or with reference to FIG. 2 for the server. Further exemplary embodiments are a vehicle 400 having a device 30.

The interface 32 shown in FIG. 4 can correspond, for example, to one or more inputs and/or one or more outputs for receiving and/or transmitting information, for example, in digital bit values, based on a code, within a module, between modules, or between modules of various entities. The interface 32 can be designed, for example, to communicate via a (radio) network or a local connection network with other network components.

In exemplary embodiments, the data processing circuit 34 can correspond to arbitrary controller or processor or a programmable hardware component. For example, the data processing circuit 34 can also be implemented as software which is programmed for a corresponding hardware component. The data processing circuit 34 can insofar be implemented as programmable hardware having correspondingly adapted software. Arbitrary processors, such as digital signal processors (DSPs) can be used here. Exemplary embodiments are not restricted here to a specific type of processor. Arbitrary processors or also multiple processors are conceivable for implementing the data processing circuit 34.

As shown in FIG. 4, the interface 32 can be coupled with the respective data processing circuit 34 of the device 30. In examples, the device 30 can be implemented by one or more processing units, one or more processing devices, an arbitrary means for processing, such as a processor, a computer, or a programmable hardware component which can be operated using correspondingly adapted software. The described functions of the data processing circuit 34 can also be implemented in software, which is then executed on one or more programmable hardware components. Such hardware components can be a multipurpose processor, a digital signal processor (DSP), a microcontroller, etc. The data processing circuit 34 can be capable of controlling the interface 32 so that any data transmission which takes place via the interface 32 and/or any interaction in which the interface 32 can participate can be controlled by the data processing circuit 34.

In one embodiment, the device 30 can comprise a memory and at least one data processing circuit 34, which is functionally coupled with the memory and is configured so that it performs one of the above-described methods.

In examples, the interface 32 can correspond to any means for obtaining, receiving, transmitting, or providing analog or digital signals or information, for example, any connection, contact, pin, register, input connection, output connection, conductor, track, etc. which enables a signal or information to be provided or obtained. The interface 32 can be wireless or wired and can be configured so that it can communicate with further internal or external components, for example, can send or receive signals or information.

In at least some exemplary embodiments, the vehicle 400 can correspond, for example, to a land vehicle, a water vehicle, an air vehicle, a rail vehicle, a road vehicle, an automobile, a bus, a motorcycle, an off-road vehicle, a motor vehicle, or a truck. The device 30 can be, for example, a part of a control device of the vehicle 400.

Further details and aspects will be mentioned in conjunction with the above-described exemplary embodiments. The exemplary embodiment shown in FIG. 3 can comprise one or more optional additional features which correspond to one or more aspects which were mentioned in conjunction with the proposed concept or one or more exemplary embodiments described above (for example, FIGS. 1-2).

Further exemplary embodiments are computer programs for performing one of the methods described herein when the computer program runs on a computer, a processor, or a programmable hardware component. Depending on the determined implementation requirements, exemplary embodiments of the invention can be implemented in hardware or in software. The implementation can be performed using a digital storage medium, for example, a floppy disk, a DVD, a Blu-ray disc, a CD, a ROM, a PROM, an EPROM, an EEPROM, or a FLASH memory, a hard drive, or another magnetic or optical memory on which electronically readable control signals are stored, which can interact or interact with a programmable hardware component such that the respective method is carried out.

A programmable hardware component can be formed by a processor, a computer processor (CPU=central processing unit), a graphics processor (GPU=graphics processing unit), a computer, a computer system, an application-specific integrated circuit (ASIC), an integrated circuit (IC), a single-chip system (SOC=system on chip), a programmable logic element, or a field-programmable gate array (FPGA) having a microprocessor.

The digital storage medium can therefore be machine-readable or computer-readable. Some exemplary embodiments thus comprise a data carrier which has electronically readable control signals capable of interacting with a programmable computer system or a programmable hardware component such that one of the methods described herein is performed. An exemplary embodiment is therefore a data carrier (or a digital storage medium or a computer-readable medium) on which the program for performing one of the methods described herein is recorded.

In general, exemplary embodiments of the present invention can be implemented as a program, firmware, computer program, or computer program product having a program code or as data, wherein the program code or the data is or are active to the effect of performing one of the methods when the program runs on a processor or a programmable hardware component. The program code or the data can also be stored, for example, on a machine-readable carrier or data carrier. The program code or the data can be provided, inter alia, as source code, machine code, or byte code and as other intermediate code.

The above-described exemplary embodiments merely represent an illustration of the principles of the present invention. It is obvious that modifications and variations of the arrangements and details described herein will be apparent to other persons skilled in the art. It is therefore intended that the invention is solely restricted by the scope of protection of the following claims and not by the specific details which were presented herein on the basis of the description and explanation of the exemplary embodiments.

### LIST OF REFERENCE SIGNS

30 device
32 interface
34 data processing circuit
100 method for controlling a diagnosis session of a vehicle
110 sending, to a server, a readiness signal
120 at least one of receiving or sending
130 initializing the diagnosis session
200 method for controlling a diagnosis session of a vehicle
210 receiving, from a vehicle terminal, a readiness signal
220 at least one of receiving or sending
230 initializing the diagnosis session
300 diagnosis session
302 first partial diagnosis session
304 second partial diagnosis session
310 starting first partial diagnosis session
350 starting second partial diagnosis session
312/352 sending a request signal
314/354 waking up the vehicle
316/356 sending an acceptance signal/rejection signal
318/358 sending the second cyclic heartbeat signal
320/360 sending the second cyclic heartbeat signal
322/362 sending a stop signal
324/364 sending a stop signal
326/356 sending a confirmation message
330 interrupting the diagnosis session
361 sending the first cyclic heartbeat signal
370 obtaining a request
372 activating a firewall setting
374 establishing an original status of the firewall
400 vehicle

1.-15. (canceled)

16. A method for controlling a diagnosis session of a vehicle, comprising:
sending, to a server, a readiness signal indicative of a readiness for the diagnosis session;
at least one of receiving, from the server, a first cyclic heartbeat signal or sending, to the server, a second cyclic heartbeat signal; and
initializing the diagnosis session based on the first cyclic heartbeat signal or the second cyclic heartbeat signal.

17. The method as claimed in claim 16, wherein:
the first cyclic heartbeat signal and the second cyclic heartbeat signal are indicative of a parameter of the diagnosis session.

18. The method as claimed in claim 16, further comprising:
ending the diagnosis session if neither the first cyclic heartbeat signal can be received nor the second cyclic heartbeat signal can be sent.

19. The method as claimed in claim 16, further comprising
ending the diagnosis session if the second cyclic heartbeat signal cannot be sent.

20. The method as claimed in claim 16, further comprising
ending the diagnosis session if the first cyclic heartbeat signal cannot be received.

21. The method as claimed in claim 16, further comprising:
changing a firewall setting of a terminal associated with the vehicle during a performance of the diagnosis session.

22. The method as claimed in claim 16, further comprising:
determining a status of the vehicle; and
ending the diagnosis session based on the determined status of the vehicle.

23. The method as claimed in claim 16, further comprising:
obtaining at least one criterion of a presence of a user of the vehicle or
obtaining a consent of the user to initialize the diagnosis session, wherein
the diagnosis session can only be initialized if at least one of the criteria has been obtained.

24. The method as claimed in claim 16, further comprising:
obtaining at least one of surroundings information or position information; and
wherein the second cyclic heartbeat signal is further indicative of at least one of the obtained surroundings information or the obtained position information.

25. The method as claimed in claim 16, further comprising:
receiving, from the server, a request signal indicative of a request for an initialization of the diagnosis session; and
wherein the readiness signal is a response signal indicative of a response to the request signal.

26. The method as claimed in claim 16, further comprising:
determining an operationally-ready status of the vehicle;
sending a final heartbeat signal of the second cyclic heartbeat signal indicative of the operationally-ready status; and
ending the diagnosis session.

27. The method as claimed in claim 16, further comprising:
determining a status of the vehicle;
determining a remaining diagnosis session time based on the status of the vehicle; and
wherein the second cyclic heartbeat signal is more indicative of the remaining diagnosis session time.

28. A non-transitory computer storage medium having a computer program for performing the method as claimed in claim 16, when the computer program runs on a computer, a processor, or a programmable hardware component.

29. A device for controlling a diagnosis session of a vehicle, comprising:
an interface for communication with a server or a vehicle terminal; and
a data processing circuit, which is designed to perform the method as claimed in claim 16.

30. A vehicle having a device as claimed in claim 29.

31. A method for controlling a diagnosis session of a vehicle, comprising:
receiving, from a vehicle terminal, a readiness signal indicative of a readiness for the diagnosis session;
at least one of sending to the vehicle terminal, a first cyclic heartbeat signal or receiving, from the vehicle terminal, a second cyclic heartbeat signal; and
initializing a diagnosis session based on the first cyclic heartbeat signal or the second cyclic heartbeat signal.

32. The method as claimed in claim 31, wherein:
the first cyclic heartbeat signal is indicative of a status request of the vehicle; and
further comprising determining a remaining diagnosis session time based on the status of the vehicle.

33. The method as claimed in claim 31, wherein:
the second cyclic heartbeat signal is indicative of a status of the vehicle; and
further comprising determining a remaining diagnosis session time based on the status of the vehicle.

34. A non-transitory computer storage medium having a computer program for performing the method as claimed in claim 31, when the computer program runs on a computer, a processor, or a programmable hardware component.

35. A device for controlling a diagnosis session of a vehicle, comprising
an interface for communication with a server or a vehicle terminal; and
a data processing circuit, which is designed to perform the method as claimed in claim 31.
